(19) United States
(12) Patent Application Publication
(10) Pub. No.: US 2013/0014061 A1
(43) Pub. Date: Jan. 10, 2013

(54) METHOD AND APPARATUS FOR TIME-BASED OPPORTUNITY AND RISK MANAGEMENT

(75) Inventors: Sunil C. Patel, Dallas, TX (US); Evan R. Dietz, Dallas, TX (US); Christopher R. Larson, Fort Worth, TX (US)

(73) Assignee: LOCKHEED MARTIN CORPORATION, Grand Prairie, TX (US)

(21) Appl. No.: 13/541,156

(22) Filed: Jul. 3, 2012

Related U.S. Application Data
(60) Provisional application No. 61/504,842, filed on Jul. 6, 2011.

(51) Int. Cl. G06F 3/048

(52) U.S. Cl. 715/841

(57) ABSTRACT

In one aspect, a computer-implemented method for use in controlling an operating environment includes: scoring a plurality of events detected within the operating environment to indicate an objective importance for a decision maker to address; presenting to the decision maker the scored events ranked relative to one another by their scores; receiving a selection by the decision maker of a particular one of the ranked events; scoring a plurality of alternative options to the selected event; presenting to the decision maker the options ranked relative to one another by their scores; receiving a selection by the decision maker of a particular one of the ranked options. In other aspects, a computing apparatus is programmed to perform such a method and a program storage medium is encoded with instructions that, when executed by computing device, perform such a method.

### CROSS-REFERENCE TO RELATED APPLICATIONS

The priority of co-pending provisional application Ser. No. 61/504,842, entitled “Method and Apparatus for Time-Based Opportunity and Risk Management”, and filed Jul. 6, 2011, in the name of the inventors Sunil C. Patel, et al., is hereby claimed pursuant to 35 U.S.C. §119(e). This application is also hereby incorporated by reference in its entirety and for all purposes as if expressly set forth verbatim herein.

### STATEMENT REGARDING FEDERALLY SPONSORED RESEARCH OR DEVELOPMENT

Not applicable.

### BACKGROUND

This section of this document introduces information from the art that may be related to various aspects of the present invention described and/or claimed below. It provides background information to facilitate a better understanding of the subject matter disclosed herein. This is a discussion of “related” art. That such art is related in no way implies that it is also “prior” art. The related art may or may not be prior art. The discussion in this section of this document is to be read in this light, and not as admissions of prior art.

Many fields of human endeavor have time-dependent opportunities and risks based on cost, schedule, or technical considerations. Typically associated with events occurring in the operating environments for these fields are a number of options to mitigate risk or capture opportunity. Many of these environments are very complex. This complexity may arise from factors such as the amount of information available about conditions in the environment, or the number events occurring in the environment, or the number of options associated with the events, or some combination of such factors.

These environments frequently challenge the abilities of even the best decision makers where there is a “man in the loop” control. The option space can quickly become overwhelming, particularly where each event has a set of benefits and drawbacks and the time to act for each event is different. If the timeline from risk/opportunity detection to mitigation/capture is represented in seconds or minutes, the cognitive workload of the decision maker becomes overwhelming.

The present invention is directed to resolving, or at least reducing, one or all of the problems mentioned above.

### SUMMARY

In one aspect, of the presently disclosed technique, a computer-implemented method for use in controlling an operating environment, the method comprising: scoring a plurality of events detected within the operating environment to indicate an objective importance for a decision maker to address; presenting to the decision maker the scored events ranked relative to one another by their scores; receiving a selection by the decision maker of a particular one of the ranked events; scoring a plurality of alternative options to the selected event; presenting to the decision maker the options ranked relative to one another by their scores; receiving a selection by the decision maker of a particular one of the ranked options. In other aspects the technique includes a computing apparatus programmed to perform such a method and a program storage medium encoded with instructions that, when executed by computing device, perform such a method.

The above presents a simplified summary in order to provide a basic understanding of some aspects of this technique. This summary is not an exhaustive overview. It is not intended to identify key or critical elements or to delineate the scope of the technique. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements, and in which:

FIG. 1 conceptually depicts the deployment and operation of one particular embodiment of the technique disclosed herein;

FIG. 2 shows selected portions of the hardware and software architecture of a computing apparatus;

FIG. 3 depicts one particular embodiment of a graphical user interface;

FIG. 4 conceptually illustrates the operation of one particular embodiment of the implementation in FIG. 1;

FIG. 5 illustrates one embodiment of a computer-implemented method for use in controlling an operating environment;

FIG. 6 illustrates a computing system on which some aspects of the presently disclosed technique may be practiced in some embodiments;

FIG. 7 conceptually depicts the deployment and operation of a second particular embodiment of the technique disclosed herein;

FIG. 8 depicts a second embodiment of a graphical user interface as is employed in the embodiment of FIG. 7;

FIG. 9 depicts one variant of the graphical user interface in FIG. 8 used in a military context; and

FIG. 10 depicts a second variant of the graphical user interface in FIG. 8 used in a civilian context.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

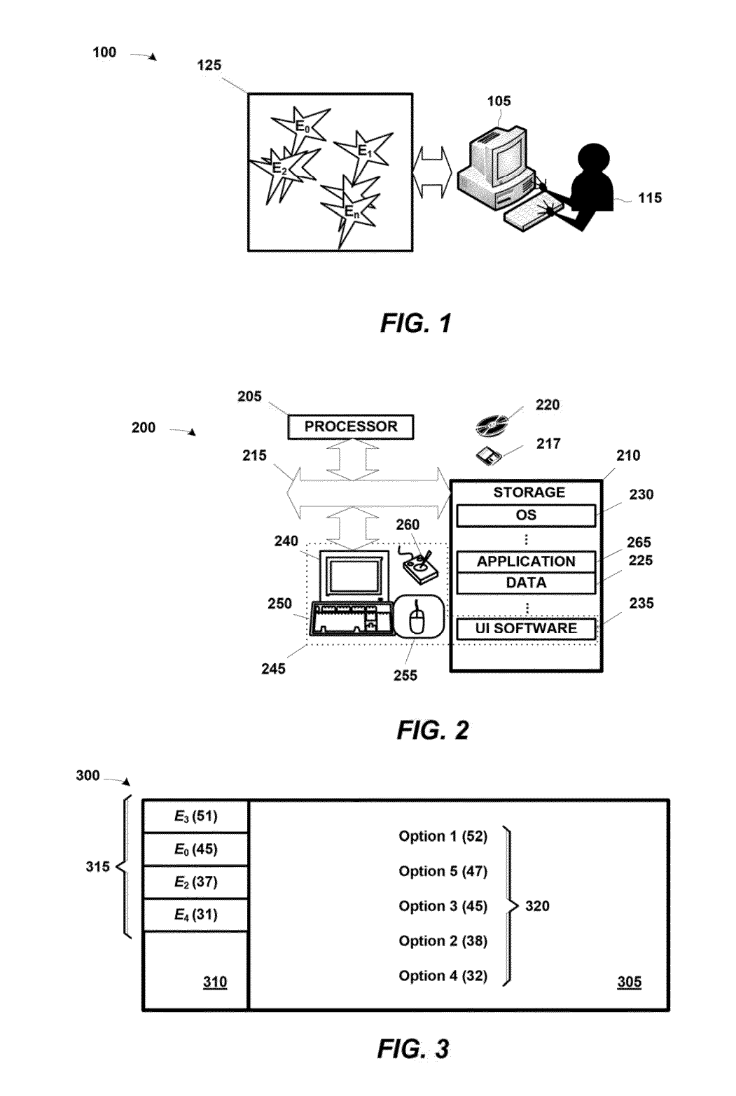

FIG. 1 conceptually depicts the deployment and operation of one particular embodiment 100 of the technique disclosed herein. A decision management system 105 is deployed to assist a decision maker 115 in addressing a plurality of events E₀-Eₙ occurring within an operational environment 125. The decision management system 105 may be embedded in the operational environment 125 or separate from it, as suggested by FIG. 1.

In the illustrated embodiment, the decision management system 105 is computer-implemented. FIG. 2 shows selected portions of the hardware and software architecture of a computing apparatus 200 such as may be employed in some aspects of the presently disclosed technique. The computing apparatus 200 includes a processor 205 communicating with storage 210 over a bus system 215. The storage 210 may include a hard disk and/or random access memory (“RAM”) and/or removable storage such as a floppy magnetic disk 217 and an optical disk 220.

The storage 210 is encoded with an application 265 and the data 225 on which it operates. The application 265, when invoked, performs the method described below. The user may invoke the application in conventional fashion through the user interface 245. Note that the precise nature of the software component by which the technique is implemented is not determinative. In alternative embodiments, the functionality of the application may be implemented in other kinds of software, e.g., a utility, a daemon, etc.

The storage 210 is also encoded with an operating system 230, user interface software 235, and an application 265. The user interface software 235, in conjunction with a display 240, implements a user interface 245. The user interface 245 may include peripheral I/O devices such as a keypad or keyboard 250, a mouse 255, or a joystick 260. The processor 205 runs under the control of the operating system 230, which may be practically any operating system known to the art.

In operation, the user interface 245 includes a graphical user interface (“GUI”) 300, shown in FIG. 3, through which the use interacts with the application 265. The GUI 300 includes two panes, a main pane 305 and a sidebar 310. In this particular view, a plurality of ranked events 315 are displayed in the sidebar. The ranked events 315 comprise events E₀-E₄, and the display includes the scores by which they are ranked as described below. This particular view also includes a plurality of “options” 320 for responding to a selected event. Each option represents a separate, alternative reaction to the event. The options 320 are also ranked and are each displayed with the score by which they are ranked as discussed further below.

Those in the art will appreciate that many aspects of the presently disclosed technique will be implementation specific. For example, the nature of the operating environment 125 will largely define the types of events upon which a given implementation operates. It will also, along with the types of events, drive the options that may be exercised responsive to those events. These and other variations will be explored further below.

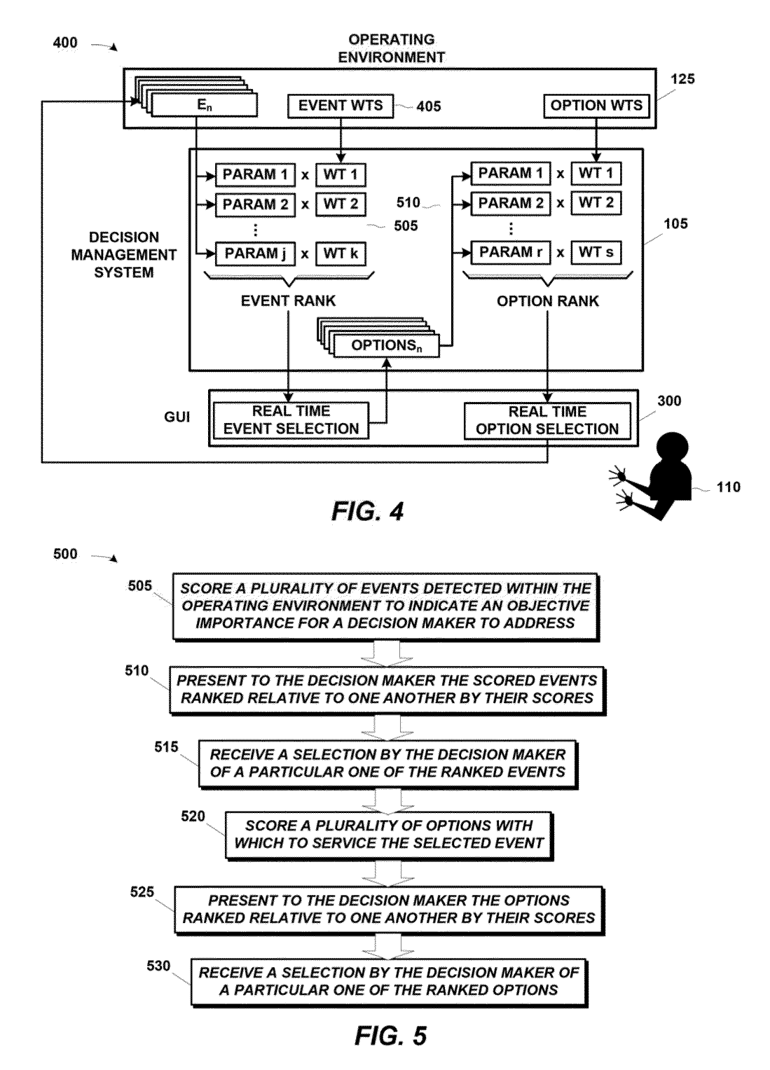

FIG. 4 conceptually illustrates the operation of one particular embodiment 400 of the implementation 100 in FIG. 1. In this particular embodiment, the decision maker 115 controls the operating environment 125 by interacting with the decision making system 105 through the GUI 300. In general, the decision making system 105 employs the method 500 of FIG. 5.

Referring now to both FIG. 4 and FIG. 5, the method 500 begins by scoring (at 505) a plurality of events E₀-Eₙ detected within the operating environment 125 to indicate an objective importance for the decision maker 115 to address. The illustrated embodiment scores the various events E₀-Eₙ by applying a plurality of weights WT₁-WTₖ to a plurality of parameters PARAM₁-PARAMⱼ. In the illustrated embodiment, the parameters are predefined and pertain to the events anticipated to be encountered in the particular operating environment 125. The weights in the illustrated embodiment are user configurable (at 405) in real time, but may be predefined in alternative embodiments.

This formulation assumes a priori knowledge that the events have occurred. The decision making system 105 may directly sense or detect the occurrence of the event or may receive a signal from some other system (not shown) that the event has occurred. How this is done will be implementations specific given the events that may occur in the particular operating environment 125.

The method 500 continues by presenting (at 510) to the decision maker the scored events ranked relative to one another by their scores. The manner in which the presentation is made will be implementation specific. This is best shown for the illustrated embodiment in FIG. 3 in one implementation in the sidebar 300. However, the ranked events may also, at this point, be displayed in the main pane 305. The embodiment of FIG. 3 presents the events with their scores to assist the decision maker 115 in assessing the relative significance of the scores. For example, if the highest scored event has a score three (3) times higher than the next highest score, that may strongly indicate that that event should be selected. Similarly, if two events contain are scored evenly or very closely, that may indicate that there is not any particular objective merit in selecting one over the other. The scores may be omitted in alternative embodiments.

Next, the decision management system 105, in FIG. 1, receives (at 515) a selection by the decision maker 115 of a particular one of the ranked events E₀-Eₙ. The manner in which the decision maker 115 enters the selection will be implementation specific depending on the user interface. The user interface may include a touch screen so that the decision maker 115 need only touch the button representing the selected event with their finger. Or, the user interface might be “click and drag” so that the decision maker 115 makes his indication by clicking on a button indicated by a cursor. Still further, the selection may be entered by tabbing through the display to highlight an event and then pressing the “ENTER” button on a keyboard. Any such interface known to the art may be employed.

The decision management system 105 then scores (at 520) a plurality of alternative reactions to the selected event. Each alternative reaction presents an “option” for the decision maker 115. In the illustrated embodiment, since the events are known a priori, so too are the alternative options. The illustrated embodiment scores the various alternative options Option₀-Optionₙ similarly to the way in which it ranks the events although this is not necessary to the practice of the invention. As with the event ranking, other techniques may be used to rank the options.

The decision management system 105 ranks the options by applying a plurality of weights WT₁-WTₛ to a plurality of parameters PARAM₁-PARAMᵣ. In the illustrated embodiment, the parameters are predefined and pertain to the options that will be available for the given selected event. The weights are user configurable (at 410) in real time in the illustrated, but may be predefined in alternative embodiments.

The decision management system 105 then presents (at 525) to the decision maker 115 the options ranked relative to one another by their scores. Again, as with the presentation of the ranked events, the manner in which the presentation is made will be implementation specific. This is best shown for the illustrated embodiment in FIG. 3. The illustrated embodiment presents the events with their scores to assist the decision maker 115 in assessing the relative significance of the scores. For example, if the highest scored option has a score three (3) times higher than the next highest score, that may strongly indicate that that event should be selected. Similarly, if two events are scored evenly or very closely, that may indicate that there is not any particular objective merit in selecting one over the other.

Next, the decision management system 105 receives (at 530) a selection by the decision maker 115 of a particular one of the ranked options. Again, as with the receipt of the event selection, the manner in which the decision maker 115 enters the selection will be implementation specific depending on the user interface. Any suitable interface known to the art may be employed.

Note that the various acts described above need not necessarily be performed in a “batch” type approach. Events may be scored as they are detected or sensed and introduced into the ranked events being displayed to the user. This implies that the rankings presented to the user may vary over time. The scoring for events may also be “updated” in real time to reflect changes in the operating environment or the decision maker's priorities as reflected in the weights. The rankings may therefore change not only by introduction of new events, but because of changes in the operating environment or changes in the scoring.

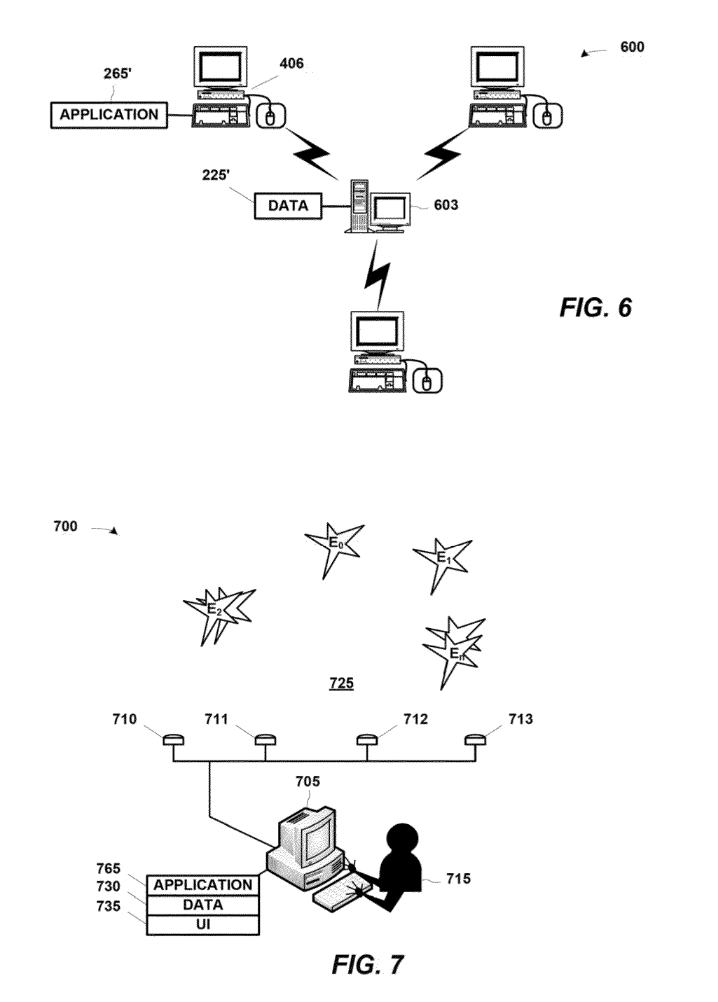

FIG. 6 illustrates a computing system on which some aspects of the presently disclosed technique may be practiced in some embodiments. Note that there is no need for the data 225 to reside on the same computing apparatus 200 as the application 265 by which it is processed. Some embodiments may therefore be implemented on a computing system, e.g., the computing system 600 in FIG. 6, comprising more than one computing apparatus. For example, the data 225 may reside in a data structure residing on a server 603 and the application 265, by which it is processed on a workstation 606 where the computing system 600 employs a networked client/server architecture.

However, there is no requirement that the computing system 400 be networked. Alternative embodiments may employ, for instance, a peer-to-peer architecture or some hybrid of a peer-to-peer and client/server architecture. The size and geographic scope of the computing system 400 are not material. The size and scope may range anywhere from just a few machines of a Local Area Network (“LAN”) located in the same room to many hundreds or thousands of machines globally distributed in an enterprise computing system.

As is apparent from the discussion above, some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities that will physically transform the particular machine or system on which the manipulations are performed or on which the results are stored. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Furthermore, the execution of the software's functionality transforms the computing apparatus on which it is performed. For example, acquisition of data will physically alter the content of the storage, as will subsequent processing of that data. The physical alteration is a “physical transformation” in that it changes the physical state of the storage for the computing apparatus.

Note also that the software implemented aspects of the presently disclosed technique are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

Two particular embodiments of the presently disclosed technique will now be disclosed to help illustrate its scope and how it may be variously adapted in some circumstances. The first embodiment is a military context. The second embodiment is a civilian context. Both these embodiments are generically and conceptually depicted FIG. 7.

Turning now to the embodiment 700 of FIG. 7, the computing apparatus 705 is embedded in the operational environment 725. The computing apparatus 705 interacts with the operational environment 725 through the sensors 710-713 to detect the occurrence of the events E₀-Eₙ. As mentioned above, and as will become apparent from the disclosure below, the implementation of the sensors 710-713 will depend upon the nature of the embodiment. The computing apparatus 705 furthermore hosts an application 765, data 730, and user interface software 735 in a manner such as is described above with other embodiments. The user 715 interacts with the application 765 through the GUI of the user interface software 735.

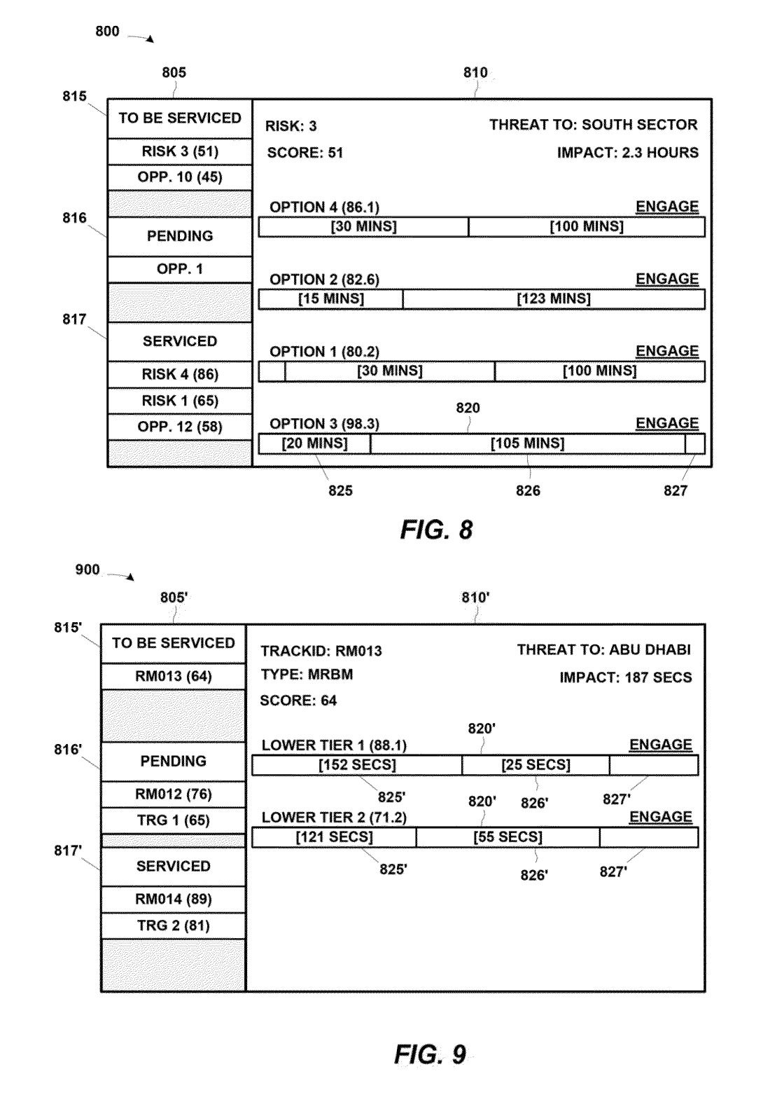

FIG. 8 depicts a GUI 800 as may be employed in the embodiment of FIG. 7 that is generalized from the military and civilian implementations mentioned above. The GUI 800 includes a sidebar 805 and a viewing pane 810. The information displayed in the viewing pane 810 is associated with the information displayed in the sidebar 805 in the manner described below.

The sidebar 805 presents three queues 815-817. The first queue 815 presents the events “to be serviced” in that they have been selected by the user 715 to be addressed. In this particular embodiment, this queue 815 is automatically populated with by the application 765 with detected events as those events are detected. In FIG. 8, the RISK 3 and OPPORTUNITY (“OPP”) 10 have been selected.

The second queue 816 presents events that are “pending”. These events are pending in the sense that the user has already selected an option to address the event but the application 765 is awaiting confirmation from system resources implementing the selected option that the option is still viable. There is only one pending event shown in the queue 816, that being OPP 1.

The third queue 817 lists events that have been “serviced”. These are events that the user 715 has already addressed and that the system tasked with implementing the selected option has confirmed that it is viable. In this example, events RISK 4, RISK 1, and OPP 12 are shown as having been serviced. The events listed in each of the queues 815-817 are ordered within the queue top to bottom by their respective scores.

The viewing pane 810 presents options associated with a selected event from the “to be serviced” queue 815. In the illustrated example, the selected event is RISK 3, and the options OPTION 1-OPTION 4 for responding to RISK 3 are displayed in the viewing pane 810. The options are ordered according to their respective scores which are shown in parentheses. The viewing pane 810 also displays selected information about the event including its name, score, the potential consequence of the event, and the time remaining in which to act.

Those in the art having the benefit of this disclosure will appreciate that labels such as “OPPORTUNITY”, “RISK”, and “OPTION” used in this example were chosen for their generic nature. These types of labels may be tailored to individual embodiments where desired and/or appropriate. The two implementations of this embodiment discussed below provide examples of how this may be done.

Each option is presented by name and score. In this particular embodiment, each option is also presented by an associated timeline impacting the implementation of that option. Consider, for example, OPTION 3, whose timeline bar 820 has three sections 825-827. The first section 825 represents the amount of time before the event may be “engaged”, or some action represented by the option can be taken. This may also be called a waiting period. Note, however, that the instruction to engage may be given on the understanding that the requisite period must pass before the instruction can be executed. The second section 826 represents the time period or window in which the option may be exercised to engage the event. The third section 827 is the period in which the option is no longer valid. This does not mean that the event need no longer be engaged, just that the respective option is no longer valid. Note that when OPTION 3 expires in the illustrated embodiment, OPTION 1, OPTION 2, and OPTION 4 will still be available.

In operation, over time, the events E₀-Eₙ are detected by the sensors 710-713, shown in FIG. 7, and communicated to the computing apparatus 705, which stores it as a part of the data 730. The application 765 analyzes the data 730, including that obtained from the sensors 710-713, and communicates with the user 715 via the GUI 800, shown in FIG. 8. The analysis will depend on the nature of the events and sensors 710-713. The analysis includes a ranking of the events as described above. The ranked events are, in this particular embodiment, then automatically loaded into the “to be serviced queue” 815 ranked by their scores.

The user 715 can then select from the queue 815 which events they wish to deal with, or “service”. Note that the user 715 may pick whichever events raise themselves most prominently and is not obligated to select them in the order of their ranking. As described above, the selection itself will depend upon the technical capabilities of the user interface. The user 715 may tap the representation of the event if the interface includes a touchscreen or may click on a button representing the event with a mouse.

In alternative embodiments, the application 765 may automatically select one or more events based on their score. For example, the application 765 may employ a rule that any event whose score exceeds a predetermined threshold is automatically “selected” to be serviced. Another rule may be that any event that has been in the queue 815 beyond a certain period of time or for which servicing options are expiring may be automatically “selected”. Some embodiments may use all or any of these variations,

Options for servicing one of the events are then presented to the user 715 in the viewing pane 810. This event can again be selected by the user 715 or the application 765 may default to displaying options for the event with the top score. Thus, this particular embodiment is not necessarily locked into servicing events in order of their score. The options are also scored as described above and are presented ordered by their scores, but could be ordered by time constraints in alternative embodiments. Each option presented in this particular embodiment also is accompanied by a timeline bar indicating certain timing considerations for the exercise of that option as discussed above. The user 715 may select one of the presented Options by so indicating using the “engage” indication on the viewing pane 810 that is associated with that option.

The user 715 then selects one of the displayed options for “servicing” the selected event. The various options will typically implicate the operation and use of other system resources. In this particular embodiment, the application 765 queries the system resource for the selected option to confirm that the selected option is still viable. During the pendency of the query, the application 765 moves the selected event to the “pending” queue 816.

Once a selected option is confirmed as viable, the event then moves to the “serviced” queue 817. As apparent from the discussion above, there may be some time before the event can be engaged by any particular option. The events that have been serviced therefore remain in the queue 817 until such time as the event is engaged in accordance with the wait time for the selected option. Once the event is engaged, in this particular embodiment, the event is removed from the queue 817.

In each of the queues 815-817 and in viewing pane 810, information is ranked by the scores accorded thereto. The scores, and therefore the relative ranking, are not necessarily static in all embodiments. The user 715 may manually reset various weights and/or parameters used in scoring process. Or, the information upon which the scoring process operates may be updated, triggering a rescoring resulting in a different score. Still other variations on this theme may be realized in alternative embodiments. The relative rankings of the presented information may therefore change over time.

FIG. 9 depicts one variant 900 of the graphical user interface 800 in FIG. 8 used in a military context. Integrated Air and Missile Defense (“IAMD”) and Fires operations are both very complex problems in today's world of mass proliferation of Tactical Ballistic Missiles (“TBM”), Cruise Missiles (“CM”), and Air Breathing Threats (“ABT”). A very credible scenario is that of a mass attack of relatively cheap threats in hopes of exhausting defensive capabilities. The presently disclosed technique uses physics based prediction algorithms to conduct Threat Evaluation (“TE”) and conducts engage ability of all potential weapon systems available for Weapon Assignment (“WA”). This is the process followed for the defensive end of the fight.

More particularly, the presently disclosed technique uses physics-based prediction algorithms to predict launch points of TBM, CM, and ABT threats to conduct Fires Operations to destroy enemy Launch Areas of Interest (“LAI”). This is the process followed for the offensive end of the fight. In this IAMD example defensive counter air is risk mitigation and fire operations against predicted LAIs are opportunities (taking away the enemy's offensive capability). The highest bidding weapon system (based on weighting factors) is highlighted in the GUI 900 as the best potential shooter.

For instance, assume there is a total of three TBM threats detected as incoming. They have all been propagated forward in time using prediction algorithms that have decided that the threats are all threatening prioritized defended areas. Each of these threats therefore constitutes an “event” providing one or more opportunities for engagement. The three TBM threats are identified as RM012-RM014 and in themselves present risks for engagement. Two of the three incoming threats have been propagated backwards in time using prediction algorithms to calculate the LAIs. These LAIs present opportunities for engagement and are identified as TARGET1, or “TRG1”, and TARGET2, or “TRG2”.

Referring to the side bar 805′, there are again three queues 815′-817′. The risk RM13 is in the “to be serviced” queue 815′; the risk RM012 and the opportunity TRG1 are in the “pending” queue 816′, and the risk RM014 and the opportunity TRG2 are in the “serviced” queue 817′. Each event is accompanied by a score and is ranked relative to the other events in the respective queue by those scores.

In FIG. 9, the event RM013, an incoming TBM threat, has been selected. The display indicates that it has been given a relative threat score of 64 compared to the other risks and opportunities in the scenario. Information regarding the event RM013 is displayed in the viewing pane 810′. The information contains not only the unique identifier “RM013” and score, but also a “type” for the event, the projected impact location, and the projected impact time. It shows two potential weapon systems LOWER TIER 1 and LOWER TIER 2 that will have engage ability with LOWER TIER 1 having the highest bid (best fit based on pairing algorithm and weighting factors within the system). LOWER TIER 1 and LOWER TIER 2 therefore represent options for engaging the event identified as RM013.

Each of the options is presented with a timeline bar 820′, comprised of three segments. The segment 825′ represents the time required to wait until that weapon system can engage the threat. The segment 826′ represents the launch window to intercept the threat. The segment 827′ represents the time period that the threat will still be flying to the impact point but the weapon system can no longer engage.

With the GUI 900, the user has operational situational awareness for each threat, opportunity, and weapon system available. The user reduces his or her workload and manages the battle with better decision aids than what would normally be provided in conventional practice. This leads to defeating the threat earlier, with less resource expenditure, and taking away the enemies ability to further wage war.

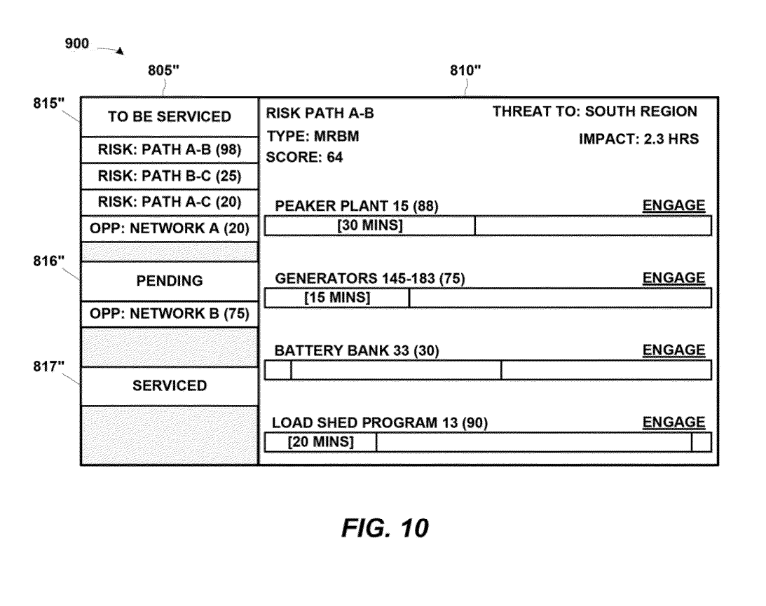

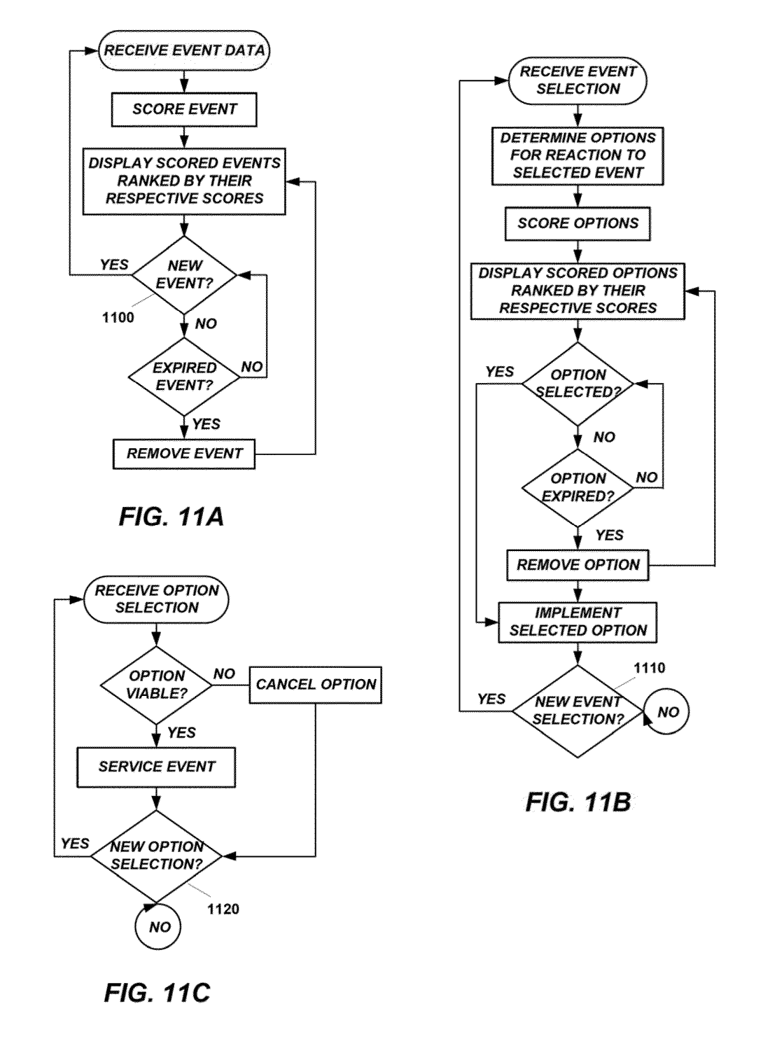

FIG. 10 depicts a second variant 1000 of the graphical user interface in FIG. 8 used in a civilian context. Utilities distribute power from sources to loads via a series of pathways (substations, electrical lines, etc.). One set of risks under constant watch is the congestion of these pathways. As demand rises or the size, location and quantity of sources changes, the pathway congestion changes accordingly. Too much congestion could lead to brown- or black-outs. Too little congestion could be an indicator of wasted money on unneeded supply or underutilized investment in pathways.

For instance, assume pathway A-B supplies power across a geographical region in the South. In the early morning of a late spring day, news reports indicate a warmer than usual day. Prediction algorithms begin to pick up an out-of-tolerance condition (i.e., excessive current) and pathway A-B is placed in the ‘to be serviced’ queue 815″ within the sidebar 805″ of the risk mitigation GUI 1000. Note the presence of other risks and opportunities in the “pending” queue 816″ and the “serviced” queue 817″.

Clicking on the risk PATH A-B, the operator is presented with a series of mitigation options in the viewing pane 810″. Each one represents a dispatchable source or load available to him. A dispatchable source may be a natural gas peaker plant, diesel generators, or a battery bank. Each source can be measured based on its location, startup/spinup time, instantaneous power, total capacity, and cost per kW hour. Similarly, a dispatachable load could represent a series of opt-in energy programs for which consumers allow the utilities to cycle their air conditioners in exchange for a rebate check. Similarly, the opt-in programs can be measured in terms of location, shutdown times, instantaneous power saved, total power saved, and the cost per kW hour. Each option is associated with a timeline bar 820″ comprised of three segments 825″-827″.

The various measurement parameters are fed through a set of user-defined weights, summed and then normalized to produce risk mitigation option “bids” as described above. Those bids are displayed next to the option name with the maximum value highlighted in order to ease the operator's cognitive workload in making a decision. A separate set of parameters are applied when determining the urgency of pathway A-B when compared against A-C, and B-C.

The opportunities listed in the “to be serviced” queue should also be noticed. These might represent ways to save money or time, amongst other factors. These can be seen as proactive measures to take advantage of a situation, many times heading off a problem before it shows up as a risk.

The GUI 1000 then, like those discussed above, provides the user with operational situational awareness for each risk and opportunity as well as the options available for engaging them. The user reduces his or her workload and efficiently manages the situation with better decision aids than what would normally be provided. This leads to defeating defusing the situation earlier and more efficiently with less disruption and resource expenditure.

Those in the art having the benefit of this disclosure will realize further variation on the theme presented above. For example, the discussion of one particular embodiment mentions that the application can, in certain circumstances, “select” an event from the “to be serviced” queue for consideration by the user. This principle can be extended so that the application can, again in certain circumstances, automatically “select” an option for engaging the event. Factors in whether a circumstance would mitigate for such action might include, for example, the direness of the consequences of leaving the event unengaged, the number of options available at a given time, the amount of resources consumed by available options, the complexity of executing the option, the amount of time remaining in which to engage the event, etc.

Still other variations may be appreciated by those skilled in the art in light of the present disclosure. For another example, the discussion above presents the flow of the decision making process as a more or less sequential series of steps. FIG. 5, for example, presents a series of actions in a sequential fashion. Those in the art having the benefit of this disclosure will appreciate that this is not necessarily required in all embodiments.

The illustrated embodiments, in general, have three areas of activity. The first is in the receipt, scoring, and display of events, the second is in the scoring and presentation of options associated with a selected event, and the third is in the servicing of the selected event using the selected option. These areas may be active in parallel or in sequence, depending on the embodiment. FIG. 11A-FIG. 11C present particular embodiments of three logic flows for the three areas of activity.

FIG. 11A generally presents a particular logic flow for the receipt, scoring, and display of events. Those skilled in the art will recognize that the decision point 1100 launches a loop in which the logic flow waits for a new event while looking for and removing “expired” events. An expired event may be, for example, an event which was not or cannot be timely engaged. Note that this activity is independent of the two other areas of activity.

FIG. 11B generally presents a particular logic flow for the scoring and presentation of options associated with a selected event. The logic flow is initiated by an event selection as previously described, but is otherwise independent of the other two areas of activity. Again, those in the art will recognize that the decision point 1110 initiates a loop in which, after an option is selected for a selected event, the logic flow waits until another event is selected.

FIG. 11C generally presents a particular logic flow for the servicing of the selected event using the selected option. The logic flow is initiated by the selection of an option and includes, for this particular embodiment, a branch by which the option is examined for viability as described above. Again, those in the art having the benefit of this disclosure will appreciate that the decision point 1120 will result in a loop in which various events are successively serviced.

The phrase “capable of” as used herein is a recognition of the fact that some functions described for the various parts of the disclosed apparatus are performed only when the apparatus is powered and/or in operation. Those in the art having the benefit of this disclosure will appreciate that the embodiments illustrated herein include a number of electronic or electro-mechanical parts that, to operate, require electrical power. Even when provided with power, some functions described herein only occur when in operation. Thus, at times, some embodiments are “capable of” performing the recited functions even when they are not actually performing them—i.e., when there is no power or when they are powered but not in operation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A computer-implemented method for use in controlling an operating environment, the method comprising:
scoring a plurality of events detected within the operating environment to indicate an objective importance for a decision maker to address;
presenting to the decision maker the scored events ranked relative to one another by their scores;
receiving a selection by the decision maker of a particular one of the ranked events;
scoring a plurality of options with which to service the selected event;
presenting to the decision maker the options ranked relative to one another by their scores; and
receiving a selection by the decision maker of a particular one of the ranked options.

2. The method of claim 1, wherein the events present risks.

3. The method of claim 1, wherein the events present opportunities.

4. The method of claim 1, wherein the scoring includes a assigning a plurality of weights to a plurality of parameters associated with each respective event.

5. The method of claim 4, wherein the parameters are predefined.

6. The method of claim 4, wherein the weights are predefined.

7. The method of claim 4, wherein the weights are user configurable in real time.

8. The method of claim 1, wherein the alternative actions include actions that overlap.

9. The method of claim 1, wherein the ranked events and the ranked options are displayed simultaneously.

10. The method of claim 1, further comprising inquiring of a system resource whether a selected option is still viable for execution.

11. The method of claim 10, further comprising displaying the pending status of the selection while the inquiry is made.

12. The method of claim 11, further comprising displaying the serviced status of the selected event when the viability of the selected option is confirmed.

13. The method of claim 1, further comprising displaying the serviced status of the selected event.

14. A computing apparatus programmed to perform a computer-implemented method for use in controlling an operating environment, the method comprising:
scoring a plurality of events detected within the operating environment to indicate an objective importance for a decision maker to address;
presenting to the decision maker the scored events ranked relative to one another by their scores;
receiving a selection by the decision maker of a particular one of the ranked events;
scoring a plurality of options with which to service the selected event;
presenting to the decision maker the options ranked relative to one another by their scores; and
receiving a selection by the decision maker of a particular one of the ranked options.

15. A program storage medium encoded with instructions that, when executed by computing device, perform a computer-implemented method for use in controlling an operating environment, the method comprising:
scoring a plurality of events detected within the operating environment to indicate an objective importance for a decision maker to address;
presenting to the decision maker the scored events ranked relative to one another by their scores;
receiving a selection by the decision maker of a particular one of the ranked events;
scoring a plurality of options with which to service the selected event;
presenting to the decision maker the options ranked relative to one another by their scores; and
receiving a selection by the decision maker of a particular one of the ranked options.

16. The computing apparatus of claim 14, wherein the scoring in the programmed method includes a assigning a plurality of weights to a plurality of parameters associated with each respective event.

17. The computing apparatus of claim 14, wherein the ranked events and the ranked options are displayed simultaneously.

18. The computing apparatus of claim 14, wherein the programmed method further comprises inquiring of a system resource whether a selected option is still viable for execution.

19. The program storage medium of claim 15, wherein the scoring in the method includes a assigning a plurality of weights to a plurality of parameters associated with each respective event.

20. The program storage medium of claim 15, wherein the method further comprises inquiring of a system resource whether a selected option is still viable for execution.
